(19) United States
(12) Patent Application Publication
(10) Pub. No.: US 2026/0192418 A1
(43) Pub. Date: Jul. 9, 2026

(54) Tool for adjusting feet for furniture items and the like

(71) Applicant: Leonardo S.r.l., Figino Serenza (CO) (IT)

(72) Inventor: Carlo Cattaneo, Figino Serenza (CO) (IT)

(21) Appl. No.: 19/555,581

(22) Filed: Mar. 3, 2026

Related U.S. Application Data
(63) Continuation of application No. 17/995,704, filed on Apr. 30, 2021, now abandoned.

(30) Foreign Application Priority Data
May 11, 2020 (IT) 102020000010504
May 11, 2020 (IT) 102020000010510
Apr. 27, 2021 (IT) 202021000002198

(51) Int. Cl. B25B 13/08; A47B 91/02; B25B 13/48; B25B 13/50

(52) U.S. Cl. CPC B25B 13/08; A47B 91/024; B25B 13/48; B25B 13/50

(57) ABSTRACT

A tool for controlling a controlled element of a height adjustable foot of a furnishing item and the like includes an engagement portion and a handle coupled to the engagement portion and having two arms shaped to embrace an outer edge of the height-adjustable foot and keep the engagement portion associated laterally with the adjustable foot. The engagement portion is arranged between the two arms and includes a toothed section that extends over a rounded area of the surface between the two arms of the handle so as to engage radial septa or seats defined in the controlled element and converging toward a central axis of the adjustable foot. The toothed section is shaped as an arched and rounded tooth extending toward one of its free ends in the direction from one arm to the other.

### FIELD OF THE INVENTION

The present invention relates to a tool for adjusting feet for furnishing items and the like.

### BACKGROUND OF THE INVENTION

A wide variety of feet, in particular adjustable feet, can be provided in the field of feet for furniture and similar furnishing items. Various types of adjustable feet are used, in fact, such as feet with front adjustment directly installed on the furniture by the seller, but feet are also used that can be installed and adjusted by the end customer or consumer of the furniture, that, for example, can also be assembled, like the furniture, by the end customer.

Furniture or furnishing elements, such as kitchens, furniture, etc. must in fact be able to easily and safely reach a stable and leveled position through adjustment with these feet if they are arranged in front of the furniture, i.e. easily accessible, and also, above all, if they are arranged at the rear and are less easily accessible.

It has been seen that this type of adjustment is easier and more manageable to effect if achieved with the aid of a tool or wrench which is more maneuverable by the user, in particular for the rear feet.

GB 2535024 and DE 202018105370 relate to tools having a handle and a two-armed end suitable for adjusting supporting legs with a variable height which provide a central engagement means between the two arms.

WO 2019/043660 relates to a furniture-leveling apparatus which comprises a handle equipped with a control end-knob which actuates a pinion arranged between two arms which become engaged on the foot. The pinion engages with a rack integral with the foot.

### SUMMARY OF THE INVENTION

The general objective of the present invention is to provide a tool for adjusting feet for furnishing items capable of solving the above-mentioned drawbacks of the prior art in an extremely simple, economical and particularly functional way.

A further objective of the present invention is to provide a tool which ensures optimal action on the single foot.

Another objective of the present invention is also to provide a tool that is extremely simple, but which ensures a stable engagement on the single front foot and/or, above all, on the rear foot of the furniture or the like.

Yet another objective of the invention is to provide a tool for adjusting a foot, in particular of the type consisting of flanges transversal to its axis and radial septa converging towards the center, arranged between the flanges.

The above objectives are achieved by a tool for adjusting feet for furnishing items produced according to independent claim 1 and the following subordinate claims.

### BRIEF DESCRIPTION OF THE DRAWINGS

The structural and functional characteristics of the present invention and its advantages with respect to the known art will become even more evident from the following description, referring to the attached schematic drawings, which show an embodiment example of the same invention. In the drawings:

FIG. 1 is a perspective view of a first embodiment of a tool according to the invention positioned adjacent to a foot to be adjusted;

FIG. 2 is a view from which it can be seen how the tool in FIG. 1 can be actuated for adjusting the foot;

FIGS. 3, 4 and 5 show further perspective views with different orientations of the tool of FIG. 1;

FIGS. 6a, 6b and 6c are sectional views from above of the tool in FIG. 1 when actuated in subsequent positions;

FIG. 7 is a perspective view of a second embodiment of a tool according to the invention positioned adjacent to a foot to be adjusted;

FIG. 8 is a view from which it can be seen how the tool in FIG. 7 can be actuated for adjusting the foot;

FIGS. 9, 10 and 11 show further perspective views with different orientations of the tool of FIG. 7;

FIGS. 12a, 12b and 12c are sectional views from above of the tool in FIG. 7 when actuated in successive positions;

FIG. 13 is a perspective view of a third embodiment of a tool according to the invention positioned adjacent to a foot to be adjusted;

FIG. 14 is a view from which it can be seen how the tool in FIG. 13 can be actuated for adjusting the foot;

FIGS. 15a, 15b and 15c are sectional views from above of the tool in FIG. 13 when moved in successive positions for engaging on the foot;

FIG. 16 shows a perspective view from below of a bottom of a piece of furniture provided with front and rear feet in which a tool according to the invention is being used for adjusting a rear foot.

### DETAILED DESCRIPTION OF EMBODIMENTS OF THE INVENTION

With reference to the figures, which are illustrative and non-limiting, these show various embodiments of a tool for adjusting feet for furniture and similar furnishing items according to the present invention.

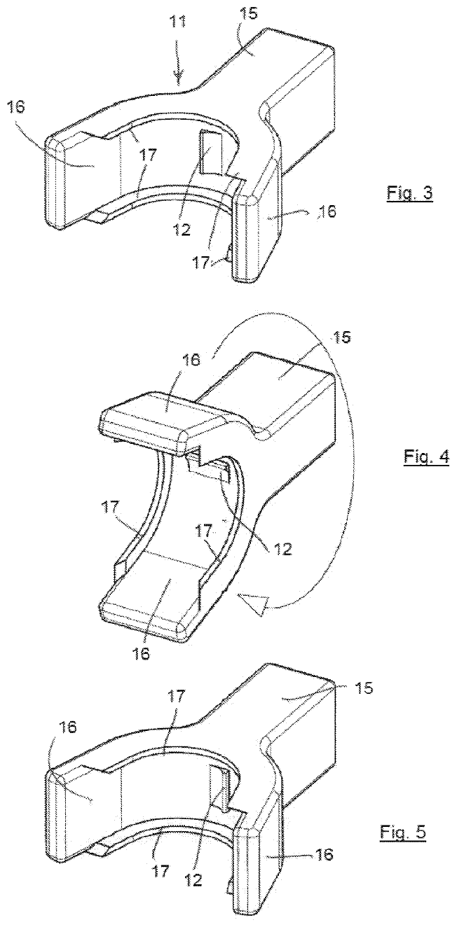

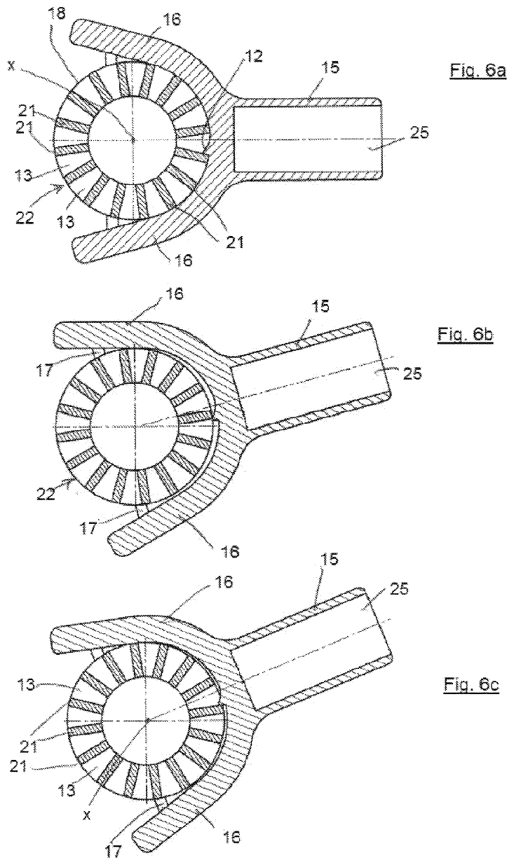

In particular, FIGS. 1 to 6c show a first embodiment of the tool which comprises a fork-shaped body 11 inside which an engagement means 12 is arranged, forming an engagement or control means, which is inserted in a seat 13 of a foot 14.

The fork-shaped body 11 provides a handle 15 from which two arms 16 extend which diverge and widen outwards. The engagement and control means 12 is produced in the form of an arched and rounded tooth rising towards its free end in the direction from one arm to the other. The two arms 16 provide edges 17 protruding towards the inside of the same which define housing and centering seats for peripheral parts of the foot 14.

In the example, the foot 14 provides in fact a pair of end flanges 18 from which a threaded stem 19 extends, suitable for being inserted, screwable and unscrewable, into a cylindrical body 20 or of another suitable shape, which can be coupled with a piece of furniture or a part thereof M. Radial septa 21 are arranged between the two end flanges 18 and are spaced apart to define said seats 13 for the tooth 12, forming a rotatable ferrule 22 of the foot which constitutes a controlled element. The radial septa 21 all converge towards a central axis X at the foot.

In particular, specifically, the two arms 16 provide edges 17 protruding towards the inside of the same, which define housing and centering seats for at least a peripheral part of the ferrule 22 which acts as a controlled element of the adjustable foot 14.

The shape of the two arms 16 that diverge and widen outwardly from the handle creates an invitation for positioning the tool on at least a part of the adjustable foot 14, for example the ferrule 22 of the foot 14.

The two arms 16 embrace the ferrule or controlled element 22 of the height-adjustable foot in order to keep the tool and the engagement or control means 12 associated laterally with the adjustable foot 14.

Furthermore, the edges 17 protruding inwardly from the arms 16 allow the tool to be fitted on the ferrule 22 of the foot with extreme safety and ease.

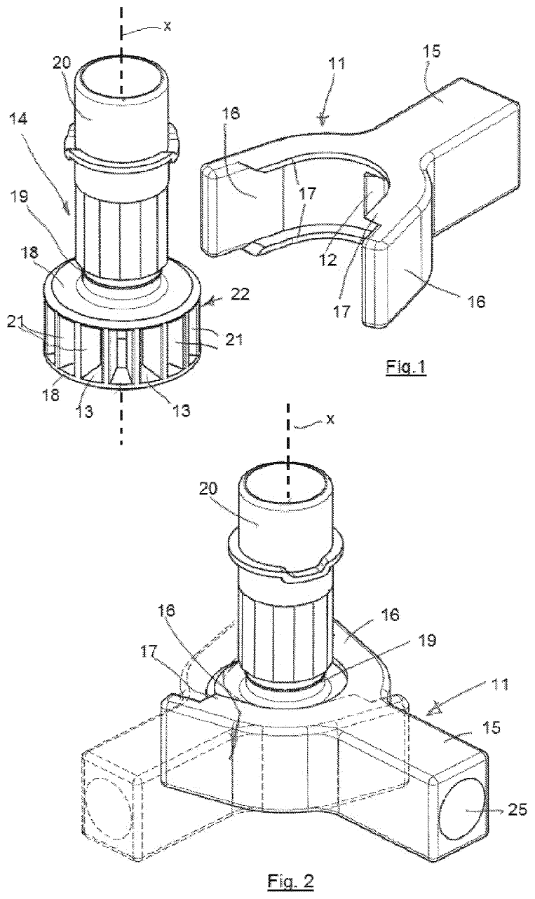

The tooth 12, also thanks to its arched shape, becomes easily and safely engaged in one of the series of seats 13 of the ferrule 22 of the foot 14 in any direction in which it is rotated or in which the tool is turned towards the foot 14. The specific function of the diverging arms 16 and of the tooth 12 is clarified by the succession of FIGS. 6a, 6b and 6c which, as already mentioned, are in a sectional view from above of the tool. These figures show the positions that the tool acquires when positioned in engagement on the ferrule 22 of the foot 14. They also show how the tooth 12 can be brought into engagement in the various seats 13 of the foot 14 so as to cause it to rotate for adjusting its height. FIG. 2 clarifies how the tool can acquire different positions so as to be rotated easily and from different actuation positions.

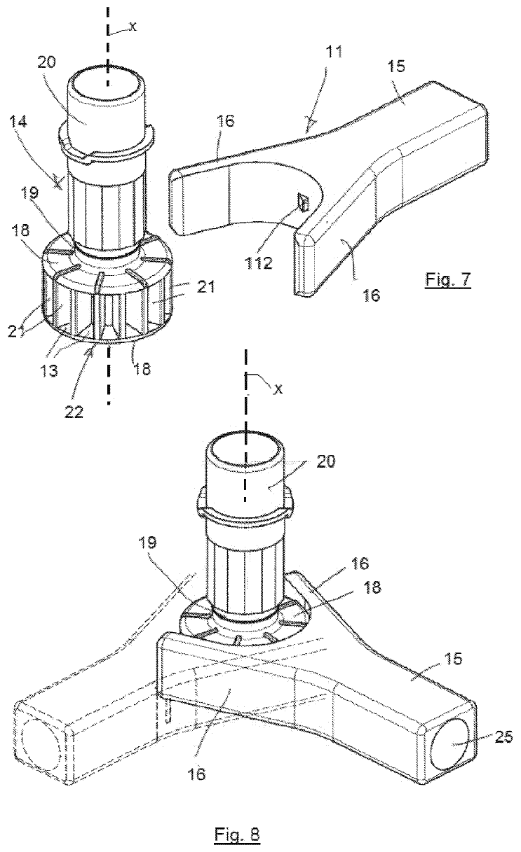

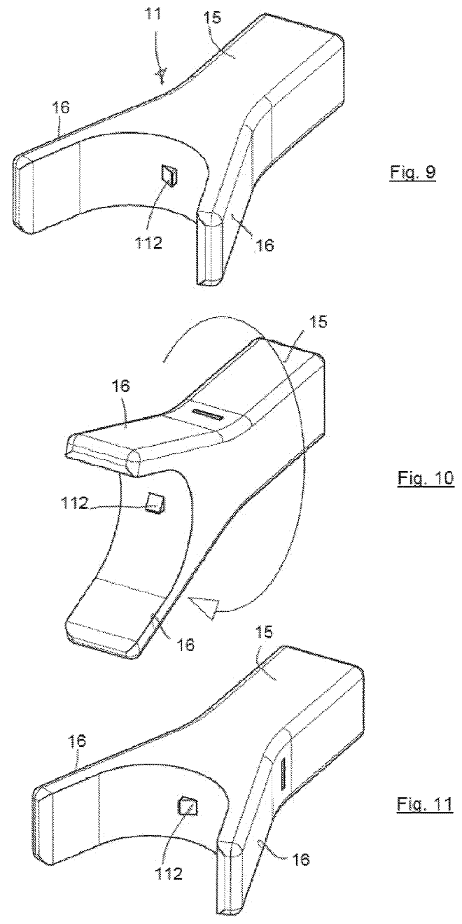

FIGS. 7 to 12c show a second embodiment of the tool in which identical elements have the same reference numbers or, if having similar functions, are preceded by “1”.

It can therefore be noted that the fork-shaped body 11 here again provides an engagement means 112 between the two arms 16, in the form of a tooth which is inserted into a seat 13 of a foot 14. The arms 16 appear in a simplified form without protruding edges and are in any case divergent from each other.

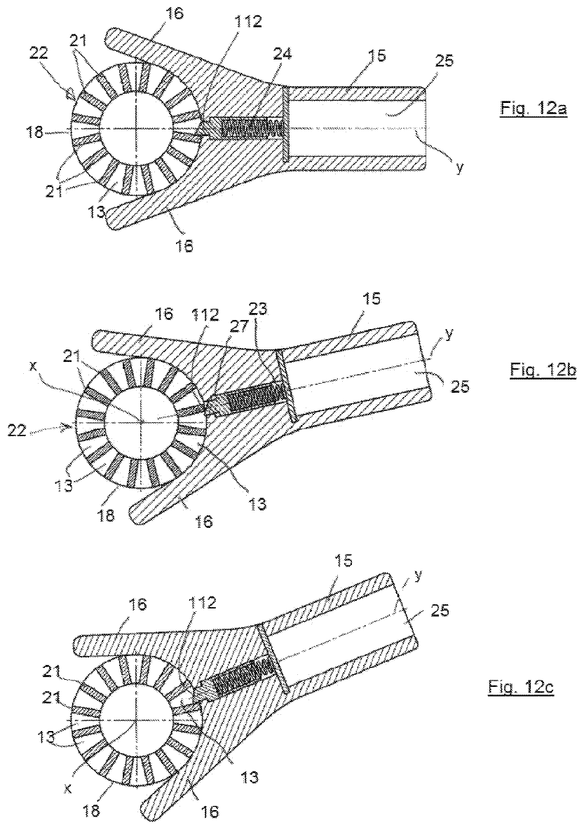

In this embodiment, however, it can be seen (FIGS. 12a, 12b and 12c) that the tooth 112 is of the yielding type according to an axis Y of the handle 15. A seat 23 is provided, in fact, in the handle 15 of the fork-shaped body 11, between the two arms of the fork-shaped body 11, in which a spring 24 or similar elastic element is arranged which pushes the tooth 112 which slides therein. The seat 23 in one of its ends facing outwardly between the arms, provides an abutment 27 for the shaped body of the sliding tooth 112 which forms a run-end for the same within the seat 23. The tooth 112 is therefore normally held in this abutment position by the spring 24, but it can move back when rotated with respect to the foot 14 to favor its rotation. This is also thanks to its arched and rounded shape rising towards its free end. FIG. 8 here again also illustrates how the tool can acquire different positions so as to be rotated easily and from different actuation positions. This also occurs thanks to the possibility of the tooth 112 sliding in the seat 23 thanks to the spring 24, as can be seen in FIGS. 12a, 12b and 12c. These figures in fact show the positions that the tooth 112 acquires in the tool when it is positioned in engagement on the ferrule 22 of the foot 14 or is caused to rotate around it.

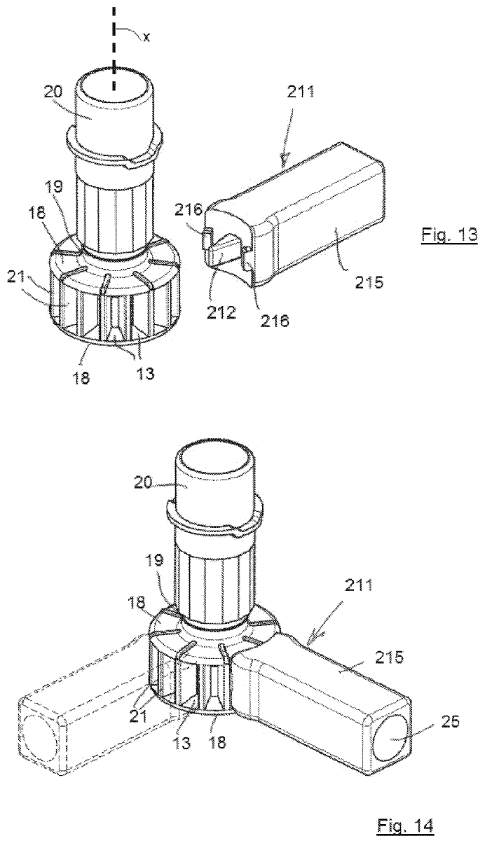

Finally, FIGS. 13 to 15c show a third embodiment of the tool according to the invention and here again identical elements have the same reference numbers, where possible, or if having similar functions, they are preceded by “2”.

The tool of the invention in this example has a fork-shaped body 211 inside which an engagement means 212 is arranged which is inserted in a seat 13 of a foot 14.

The fork-shaped body 211 provides a handle 215 from which two arms 216 extend, which converge towards a central axis X to the foot in directions parallel to those of the septa 21 present in the ferrule 22 of the foot 14. In this case, the two arms 216 are short so that they can be received and contained in the seats 13 of the ferrule 22 of the foot 14. Between these two arms 216 there is the engagement means 212 produced in the form of a tooth in a triangular shape and such as to be able to be inserted between two consecutive septa 21 of the ferrule 22. For greater engagement between two consecutive septa 21 the tooth 212 extends further with respect to the arms 216 than the handle 215.

In this case, converging arms 216 of the fork have been formed that can be inserted in the seats 13 of the ferrule 22 of the foot 14 to enable a greater force to be exerted on the ferrule 22 of the foot 14, together with the tooth 212, when the tool is actuated to cause an adjustment rotation, as shown in FIG. 14.

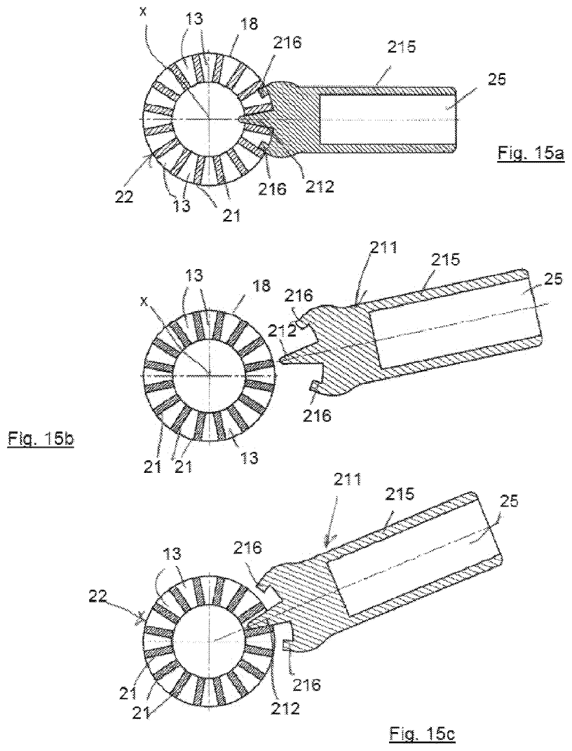

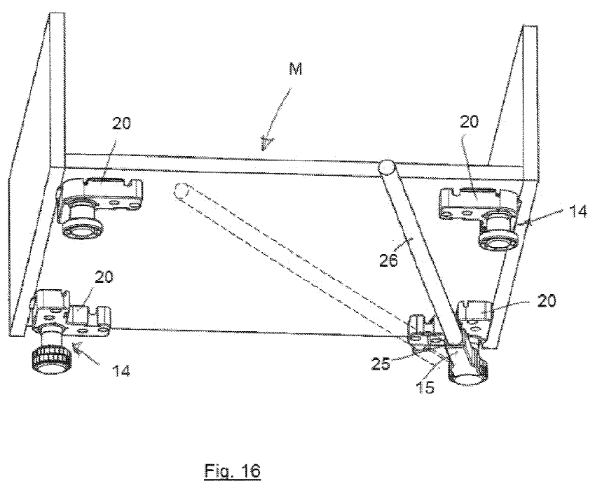

FIGS. 15a, 15b and 15c show even more clearly what the actuation phase with this tool may be or how the tool can be disengaged and re-engaged with respect to the different seats of the ferrule 22 of the foot 14.

It should be noted that in the fork-shaped body 11, 211 a blind hole 25 is provided, obtained in an axial position at the handle 15, 215 for receiving an actuation rod 26 of the tool which allows easier use. It is also possible in fact to intervene below the bottom of a piece of furniture M as shown in FIG. 16, thanks to this rod 26 by maneuvering from the outside of the furniture. The rod 26 also allows a greater torque to be applied, facilitating the rotation of the single foot 14 even in the presence of strong friction or heavy furniture that hinders this rotation.

It is therefore possible to adjust the feet from the front of the furniture frontally thanks to the use of a tool or wrench according to the present invention.

It can therefore be noted that this specific tool according to the invention allows the easy adjustment of a supporting foot or leg such as that on a piece of furniture or other furnishing item which provides this type of foot, by adjusting the foot or supporting leg in order to correct its level.

It is also evident that this specific tool is engaged with the movable or rotating part of the foot in order to allow adjustment, even if this part is difficult to reach and if a significant force must be applied to it due to the weight of the furniture.

The objective mentioned in the preamble of the description has thus been achieved.

The protection scope of the present invention is defined by the enclosed claims.

The invention claimed is:

1. A furniture adjustment system, comprising:
a furniture foot; and
a tool configured to engage the furniture foot to vary a height thereof;
wherein the furniture foot comprises,
a threaded stem, and
a ferrule rotatably engaged to a lower end of the threaded stem, the ferrule comprising,
an upper end flange and a lower end flange,
a plurality of septa connecting the upper end flange to the lower end flange, the plurality of septa extending radially from an outer perimeter of the ferrule to a longitudinal lumen of the ferrule that receives the lower end of the threaded stem, the plurality of septa being spaced from one another to define vanes arranged around the outer perimeter of the ferrule; and
wherein the tool comprises,
a handle,
two arms extending from an end of the handle in directions that diverge outwardly and from each other, the two arms defining a cavity configured to receive the ferrule of the foot between the two arms so as to laterally associate the tool to the ferrule,
engagement and control means comprising a tooth extending into the cavity between the two arms so as to engage the ferrule by penetrating into one of the vanes, the engagement and control means causing a rotation of the ferrule around a longitudinal axis of the foot when the handle of the tool is rotated around the longitudinal axis of the foot,
wherein the tooth has a wider distal body portion arranged in an interior of the handle and a narrower proximal body portion facing the cavity,
wherein a first longitudinal seat is defined within the handle and is open to the cavity defined by the two arms at a proximal end of the handle, the first longitudinal seat receiving the tooth and further housing a spring biased against the tooth so that the tooth can slide longitudinally within the first longitudinal seat to extend into the cavity or retreat into the first longitudinal seat, the seat having, at an end facing the cavity, an abutment surface that provides a run-end for the wider distal body portion of the tooth, and
wherein the narrower proximal body portion of the tooth has a free end and lateral sides facing one of the two arms, at least one of the lateral sides having an arched and rounded shape rising from the wider distal body portion toward the free end.

2. The furniture adjustment system according to claim 1, wherein the plurality of septa are shaped as radial walls extending radially from a perimeter of the ferrule, the plurality of the septa being equally spaced along an entirety of the perimeter to define the vanes as equally spaced and of equal dimensions.

3. The furniture adjustment system according to claim 1, wherein the handle has a second longitudinal seat defined longitudinally therein, the second seat being open to an outside environment at a distal longitudinal end of the handle and being configured to receive an actuation rod of the tool.

4. The furniture adjustment system according to claim 1, wherein at least portions of the two arms have upper and lower edges protruding toward an interior of the cavity, the upper and lower edges providing housing and centering seats for a peripheral portion of the ferrule.

5. The furniture adjustment system according to claim 4, wherein the upper and lower edges of the two arms protrude toward the interior of the cavity for an entirety of the two arms.

6. The furniture adjustment system according to claim 4, wherein the upper and lower edges of the two arms protruding toward the interior of the cavity for a portion of the two arms.

7. The furniture adjustment system according to claim 1, wherein the two arms have end portions that are straight and of constant width.
